(19) United States
(12) Patent Application Publication
(10) Pub. No.: US 2023/0324563 A1
(43) Pub. Date: Oct. 12, 2023

(54) Method for Creating an Environment Model

(71) Applicant: Robert Bosch GmbH, Stuttgart (DE)

(72) Inventors: Marcus O'Connor, Borken (DE); Temmo Wuebbena, Garbsen (DE)

(21) Appl. No.: 18/296,509

(22) Filed: Apr. 6, 2023

(30) Foreign Application Priority Data
Apr. 12, 2022 (DE) 10 2022 203 657.3

(51) Int. Cl. G01S 19/14; G01S 19/42

(52) U.S. Cl. CPC G01S 19/14; G01S 19/428

(57) ABSTRACT

A method for creating an environment model includes receiving measurement data from a satellite navigation system, classifying the measurement data with respect to a line of sight, and generating wall objects.

This application claims priority under 35 U.S.C. § 119 to patent application no. DE 10 2022 203 657.3, filed on Apr. 12, 2022 in Germany, the disclosure of which is incorporated herein by reference in its entirety.

The disclosure relates to a method for creating an environment model and an arrangement for performing the method.

### BACKGROUND

An environment model describes the environment around an object, e.g., the environment of a vehicle, including the roads, buildings, and open spaces and can provide, among other things, a representation of the vehicle environment. Environment models are used, e.g., in vehicles to support driver assistance systems. Such models are an important requirement for operating autonomously driving vehicles. Typically, three-dimensional (3D) environment models are employed in this context.

3D environment models are used in a wide variety of applications. Examples include:
(1) 3D raytracing, e.g., for calculating signal propagation during
(2) vehicle-to-vehicle communication,
(3) GNSS-based positioning,
(4) semantic interpretation of the vehicle environment.

Raytracing is a graphics technology that realistically calculates visible and non-visible light beams. For example, raytracing is used to determine the visibility of three-dimensional objects. An obstacle calculation is performed in this case.

Currently, 3D environment models are typically used in OSM (open street) maps, wherein their accuracy varies greatly and quality control has not yet been achieved. Whereas most buildings are typically built according to a plan, the geo-referencing of the associated wall elements is subject to very high uncertainties. In addition, the completeness and timeliness of the 3D model is often insufficient. More accurate 3D models derived from, e.g., aerial images or laser gauges are not free or openly available and must be created or purchased at great expense.

Therefore, the current 3D environment models are either unreliable or very expensive to acquire, especially if they are being generated for a larger area.

Publication DE 10 2019 211 174 A1 describes a method for determining a model used to describe at least one environment-specific GNSS profile, wherein the method receives at least one measurement data set describing at least one GNSS parameter from a GNSS signal between a GNSS satellite and a GNSS receiver. At least one model parameter for a model for describing the at least one environment-specific GNSS profile is further determined using the measurement data set received. The model is then provided in order to describe the at least one environment-specific GNSS profile.

A method for generating a three-dimensional environment model using GNSS measurements is known from publication DE 10 2019 210 659 A1. In the method, a plurality of measurement data sets are received, each describing a propagation path of a GNSS signal between a GNSS satellite and a GNSS receiver. Individual measurement data sets satisfying a first selection criterion are then selected, wherein the first selection criterion is characteristic of the presence of an object boundary along the propagation path of the GNSS signal. Object boundaries of an object in the environment of at least one GNSS receiver are then captured using the measurement data sets selected.

It should be noted that large-scale building models can also be generated as an added value based on the data included in the models through further data processing.

### SUMMARY

Presented in this context are a method having the features described below and an apparatus as described below. Embodiments of the method and apparatus are also described below.

The method presented is used to create or generate an environment model, particularly a three-dimensional environment model, said method comprising the following steps: receiving measurement data from a global satellite navigation system (GNSS), classifying the measurement data with respect to a line of sight, and generating wall objects.

Said classification of the measurement data with respect to a line of sight means that a classification is performed which classifies the data based on whether or not the data were received as a direct line of sight.

In the method presented, environment modeling is therefore performed using GNSS measurements, particularly in the case of autonomous vehicles.

Some of the terms and abbreviations used herein are explained as follows:
(1) C/N0: Carrier to noise density ratio, i.e., a measure of the signal strength of a received signal,
(2) GNSS: Global navigation satellite system, e.g., GPS (global positioning system) or Galileo,
(3) LOS: Line of sight, i.e., a direct line of sight is present,
(4) NLOS: Not line of sight, i.e., no direct line of sight is present,
(4) OSM: Open street map, i.e., freely available geospatial data,
(4) PR: Pseudo range, i.e., pseudo extension,
(5) SV: Satellite vehicle, in this case a GNSS satellite.

The method presented achieves a new approach, by means of which a 3D environment model or a building model based on GNSS measurements given knowledge of the ego position can be generated.

Further advantages and configurations of the disclosure follow from the description and the accompanying drawings.

It is understood that the aforementioned features and the features yet to be explained hereinafter can be used not only in the respectively specified combination, but also in other combinations, or on their own, without departing from the scope of the present disclosure.

### BRIEF DESCRIPTION OF THE DRAWINGS

FIG. 1 is a flow chart showing one possible procedure for the method presented.

FIG. 2 is a schematic representation of embodiment of the apparatus used to perform the method.

### DETAILED DESCRIPTION

The disclosure is illustrated schematically in the drawings on the basis of embodiments and is described in detail hereinafter with reference to the drawings.

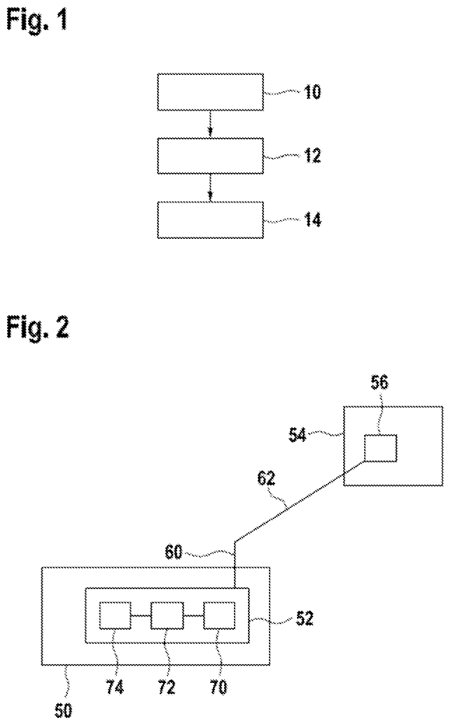

FIG. 1 is a flow chart showing one possible procedure for the method presented.

I) In a first step 10, measurement data is received. The following are noteworthy in this context:
a. The location of the receiving antenna,
b. The satellite position of the SV; given points a and b, the LOS distance between SV and the receiver antenna is also known,
c. The measured pseudo range; given points a, b and c, the PR error or the range residue is also known:

PR error=Measured PR−LOS distance.

The PR measurements are corrected for the clock error of the GNSS receiver; optionally, GNSS corrections are used which additionally contain inaccuracies, e.g., satellite positions and/or atmospheric effects,
d. Measured signal strength or C/N0.

In a GNSS receiver, the time of flight of the satellite signal between the satellite and the receiver is measured. The time when the signal is sent by the satellite for this purpose and the time when the received by the receiver is used for this purpose. Whereas the clock in the GNSS satellite is very accurate, the clock in the GNSS receiver is typically relatively inaccurate and is accordingly provided with a clock error, e.g. an offset. As a result, range measurement based on the time of flight between satellites and receivers is provided with an offset corresponding to the clock error. The term “pseudo range” also results from this. The pseudo range is not the actual range, but the range measurement associated with the clock error. In the receiver, the clock error is estimated in the position calculation as well. The estimated clock error is used to correct the range measurements of the pseudo ranges with regard to the influence of the clock error.

Preferably, the measurement data are initially measured over a longer period of time, e.g., 10 days, and using crowdsourcing. This means that the measurements of various measurement instances are collected.

II) In a second step 12, the measured data is classified with respect to LOS/NLOS. The following must be considered in this context:
a. Approach a: Classification is performed by evaluating C/N0 values:
i. A C/N0 threshold is defined.
1. The C/N0 threshold value can be determined, e.g., depending on the elevation angle of the satellite the signal is received from.
2. The C/N0 threshold can be dependent on the type of GNSS receiver.
ii. If the C/N0 value of the received signal is greater than or equal to the threshold value, then a LOS situation or signal is assumed.
iii. If the C/N0 value of the received signal is less than the threshold value, then an NLOS situation or signal is assumed.
b. Approach b: Classification is done by evaluating PR errors
i. A range residual threshold is defined.
1. The threshold value can, e.g., depend on the elevation angle of the satellite associated with the signal received.
2. The threshold value can depend on the type of GNSS receiver.
ii. If the PR error of the received signal is greater than or equal to the threshold value, then an NLOS situation or signal is assumed.
iii. If the PR error of the received signal is less than the threshold value, then a LOS situation or signal is assumed.
iv. To reduce noise in the PR measurements, e.g., what are referred to as smoothing approaches, e.g. hatch filtering, can be used.
c. A combination of approaches a and b

III) In a third step 14, a wall object is generated:
a. The following wall model characteristics can be used as the basis for creating a wall model:
i. The wall is a geometry in 3D space, e.g., a rectangular surface in 3D space.
ii. The wall is vertical, i.e., its normal vector is oriented horizontally in 3D space. This approach increases the robustness of the method, but it is not absolutely necessary.
iii. The wall can be divided into several subgeometries, e.g., several rectangular surfaces.
iv. A signal reflected through the wall follows the reflectance characteristics.
1. Signal incursion angle=Signal failure angle or normal vector angle of the wall.
2. The incident signal beam and the reflected signal beam are located in one plane.
b. Wall calculation
i. Defining an optimization problem
1. Optimization variables, e.g.:
a. North and east components of the wall base point. The wall base point is a point in the same plane of the wall model, but the wall base point need not be part of the wall model. The height of the wall base point is assumed to be, e.g., identical to the antenna height. In principle, this can be any desired height. The height is therefore not an optimization variable.
b. Any desired 3D wall base point, i.e., it is optimized across all three coordinate components.
2. Target function optimization
a. For example, formulation as a two-dimensional least squares optimization problem. The error is defined as the difference between the measured PR error of NLOS signals and the predicted PR error based on the wall model.
ii. To determine wall orientation: The wall normal vector is the difference between the wall base point and the antenna position
iii. To determine the wall size: The convex shell of the reflective points on the plane of a wall model based on the satellite and receiver positions of the measurements determining the position of the reflection points using the wall model.
iv. Suitable optimization algorithms, e. g.:
1. Nelder-Mead
2. Gauss-Newton
3. Levenberg-Marquardt
c. Optimization options
i. Cluster measurement data that lead to outliers, i.e., deliver a significantly larger targeting function when optimization problems arise. It is then tested whether these measurements belong to another wall, i.e., another wall is being calculated using these measurements.
ii. Small wall model elements can be assembled into a larger wall if, e.g., the target function is still small or does not significantly increase the optimum of the associated measurements.

FIG. 2 shows an apparatus used to perform the method presented herein in a highly simplified, purely schematic view. The illustration shows a vehicle 50 comprising an arrangement used to perform the method, which is generally denoted by reference character 52. Also shown is a satellite navigation system 54 (GNSS). A transmission antenna 56 of an exemplary satellite is illustrated in this case.

The vehicle 50 comprises a receiving antenna 60 connected to the transmission antenna 56 for exchanging data, particularly measurement data, via a line of sight 62, i.e., without obstacles. However, the line of sight 62 does not represent a limitation in this case, so it is possible to also receive measurement data via the reception antenna 60 if the transmission antenna 56 is not directly in view from the perspective of the receiving antenna 60, but rather the satellite signal sent by the transmission antenna 56, e.g., via a reflection on a building wall indirectly reaching the receiving antenna 60.

Measurement data 70 from the satellite navigation system 54 are received and classified in said apparatus 52. Wall objects 72 are then determined based on these data. A three-dimensional environment model 74 is then created based on these wall objects 72.

In an alternative embodiment, the assembly 52 can be further partitioned, wherein measurement data 70 are transmitted to a server system, where the measurement data 70 from various vehicles are merged. The classification can in this case be performed in the vehicle 50 or after transmission of the measurements or measurement data 70 to the server system on the server system. Determination of the wall objects 72 and creation of the environment model are performed on the server system based on the measurement data 70 merged therein. For example, the environment model 74 can then be provided to the vehicle 50, e.g., via download, for the elements of the vehicle-side environment model, an update to which is provided on the server system.

What is claimed is:

1. A method for creating an environment model, comprising:
receiving measurement data from a satellite navigation system;
classifying the measurement data with respect to a line of sight; and
generating wall objects.

2. The method according to claim 1, wherein the following are considered when receiving measurement data:
the position of a receiving antenna,
the position of a satellite, and
a measured pseudo range.

3. The method according to claim 2, wherein a clock error is considered for PR measurements.

4. The method according to claim 1, wherein measurement data are gathered from several measurement instances.

5. The method according to claim 4, wherein the classification is performed by evaluating C/N0 values.

6. The method according to claim 1, wherein the classification is performed by evaluating at least one PR error.

7. The method according to claim 1, wherein optimization variables are considered in the wall calculation.

8. The method according to claim 7, wherein north and east components of a wall base point are considered as optimization variables.

9. The method according to claim 7, wherein any desired wall base point is considered as the optimization variable.

10. An apparatus for updating software, wherein the apparatus is configured to perform a method according to claim 1.
